(19) United States
(12) Patent Application Publication
(10) Pub. No.: US 2009/0277126 A1
(43) Pub. Date: Nov. 12, 2009

(54) Rolled sheet product

(76) Inventors: Heidi Ailee Wollert, Littleton, CO (US); ChangQing Shen, Lakewood, CO (US); David Allen Bentley, Walnut Creek, CA (US); Joel Evan Hazy, Brighton, CO (US)

Correspondence Address: JOHNS MANVILLE, 10100 WEST UTE AVENUE, PO BOX 625005, LITTLETON, CO, 80162-5005, US

(21) Appl. No.: 12/151,367

(22) Filed: May 6, 2008

(51) Int. Cl. B32B 7/00; B32B 11/00

(52) U.S. Cl. 52/741.1; 242/160.4; 428/489

(57) ABSTRACT

A rolled sheet product, the sheet product comprising a top layer and a bottom layer, the top layer being less ductile than the bottom layer, and the top layer facing outward in the rolled sheet product. A method of packaging a sheet product comprising a top layer and a bottom layer, the top layer being less ductile than the bottom layer, comprising winding the sheet product into a roll such that the top layer faces outward.

### BACKGROUND

Sheet products comprising a top layer and a bottom layer, for example, roofing membranes, can be wound into rolls for packaging, storage, shipment, and ease of handling. When the top layer is less ductile than the bottom layer, it is possible that cracks can form in the top layer due to the tension upon unrolling, in particular in the inner portion of the roll, especially when the top layer is thin and in cold weather. What is needed is a method of avoiding cracking of such rolled sheet products upon unrolling.

### SUMMARY

Provided is a rolled sheet product. The sheet product comprises a top layer and a bottom layer. The top layer is less ductile than the bottom layer and faces outward in the rolled sheet product.

Also provided is a method of packaging a sheet product comprising a top layer and a bottom layer. The top layer is less ductile than the bottom layer. The method comprises winding the sheet product into a roll such that the top layer faces outward.

Further provided is a method of installing a roofing membrane comprising an elastomeric top layer. The method comprises winding the roofing membrane into a roll such that the elastomeric top layer faces outward, transporting the roofing membrane to a roof, and unrolling the roofing membrane on the roof.

Additionally provided is an installed roofing membrane comprising an elastomeric top layer, the elastomeric top layer experiencing less tensile stress than an amount of tensile stress experienced by the elastomeric top layer prior to installation.

### BRIEF DESCRIPTION OF THE FIGURES

FIG. 1 is a partial schematic cross-section to illustrate the layers of an exemplary highly reflective asphalt-based roofing membrane.

FIG. 2 is a cross-section view of an exemplary highly reflective asphalt-based roofing membrane.

FIG. 3 is a schematic side view of a production line that may be used to practice a method for fabricating a highly reflective asphalt-based roofing membrane.

FIG. 4 illustrates a roofing membrane having an acrylic latex top surface and an asphalt layer wound into a roll such that the acrylic latex top surface faces inward and the asphalt layer faces outward.

FIG. 5 illustrates a roofing membrane having an acrylic latex top surface and an asphalt layer wound into a roll such that the acrylic latex top surface faces outward and the asphalt layer faces inward.

FIG. 6 is a graph of a viscosity versus temperature curve for a typical elastomeric material.

FIG. 7 illustrates a roofing membrane having an acrylic latex top surface and an asphalt layer upon: a) application of the acrylic latex top surface, b) winding of the roofing membrane into a roll such that the acrylic latex top surface faces inward and the asphalt layer faces outward, and c) unrolling of the roofing membrane.

FIG. 8 illustrates a roofing membrane having an acrylic latex surface and an asphalt layer upon: a) application of the acrylic latex surface, b) winding of the roofing membrane into a roll such that the acrylic latex surface faces outward and the asphalt layer faces inward, and c) unrolling of the roofing membrane.

### DETAILED DESCRIPTION

The present disclosure relates to a method of packaging a sheet product comprising a top layer and a bottom layer, the top layer being less ductile than the bottom layer. The method comprises winding the sheet product into a roll such that the top layer faces outward. Accordingly, the present disclosure also relates to a rolled sheet product, the sheet product comprising a top layer and a bottom layer, the top layer being less ductile than the bottom layer, and the top layer facing outward in the rolled sheet product. The sheet product can be, for example, between 1 and 5 meters in width and have a length that is, for example, between 1 time and 100 times the width of the sheet product. As ductility can be defined as the ability of a material to be plastically deformed without fracture, as used herein, the phrase “less ductile” refers to a layer that is more likely to crack, in a relative comparison of different layers. The less ductile layer can be described as comparatively more rigid, and in an embodiment, the ductility of the top layer (i.e., less ductile layer) can be exacerbated when the top layer is reduced in thickness, for example, compared to the bottom layer (i.e., thinner than the bottom layer).

An exemplary sheet product comprising a top layer and a bottom layer with the top layer being less ductile than the bottom layer can be a roofing membrane, and more specifically, a roofing membrane having an elastomeric top layer and asphalt-based bottom layer. In an embodiment, the asphalt can comprise modified bitumen. In particular, a highly reflective asphalt-based roofing membrane is disclosed in U.S. Patent Application Publication No. 2006/0196596 A1, the contents of which are hereby incorporated by reference in its entirety. The highly reflective asphalt-based roofing membrane can be a cap sheet that forms the exposed layer of a multi-ply built-up roofing system, the cap sheet having a highly reflective non-asphalt based elastomeric (e.g., acrylic latex) top coating layer to provide better solar reflectivity.

In a method of manufacturing a highly reflective asphalt-based roofing membrane, a highly reflective and emissive non-asphalt based elastomeric coating, in liquid or powder form, is applied to the top surface of a black asphalt saturated and coated reinforcing substrate of the roofing membrane during manufacture of the highly reflective asphalt-based roofing membrane to provide the highly reflective asphalt-based roofing membrane with a highly reflective and emissive top surface. In an embodiment, the highly reflective and emissive top surface of the highly reflective asphalt-based roofing membrane is white. The highly reflective and emissive top surface of the highly reflective asphalt-based roofing membrane may be smooth or the highly reflective and emissive top surface of the highly reflective asphalt-based roofing membrane may be embossed or otherwise textured, may contain granules between the asphalt and the white polymeric surface coating, or may contain granules that are directly applied to the top surface of the white polymeric coating to enhance the appearance of the top surface and to provide a slip-resistant roofing surface on which the workers can walk.

The highly reflective and emissive elastomeric coating used in the highly reflective asphalt-based roofing membrane is opaque to protect the underlying asphalt layer of the asphalt saturated and coated reinforcing substrate of the roofing membrane from the deleterious effects of ultraviolet radiation and may have various additives to improve the performance of the composite, e.g., fungi growth-inhibiting agents, fire retardants, etc.

The highly reflective and emissive coating is a polymer material binder that can be colored with a white pigment, such as titanium dioxide, zinc oxide, aluminum oxide. The polymer material binder used in the highly reflective and emissive coating to carry and bind the highly reflective and emissive pigments of the coating to the top surface of the asphalt layer of the asphalt saturated and coated reinforcing substrate of the roofing membrane includes several families of binders. In an embodiment, the polymer binders are made up of amine-terminated polymer resins and/or amine-terminated chain extenders. Acrylic and isocyanate-based elastomers are particularly well suited for use as the coatings. In an embodiment, a polymer primer, which is impermeable to the oils and other components of the asphalt, is applied between the highly reflective and emissive coating layer and the top surface of the top asphalt layer of the asphalt saturated and coated reinforcing substrate to prevent the exuding of oils and other components from the asphalt into the highly reflective and emissive coating and to thereby prevent the oils and other components of the asphalt from staining and otherwise discoloring or adversely affecting the highly reflective and emissive coating layer.

The highly reflective and emissive coating may be applied to the top surface of the asphalt saturated and coated reinforcing substrate, typically after the temperature of the asphalt saturated and coated reinforcing substrate has fallen to about 300° F. or less, by a number of techniques including dip coating, spread coating, roll coating, spray coating and powder coating. The coatings are dried to maintain the cleanliness of the reflective and emissive surfaces of the highly reflective asphalt-based roofing membranes thus formed and release films or agents are applied to the highly reflective and emissive top surfaces of the highly reflective asphalt-based roofing membranes prior to winding the roofing membranes into rolls for packaging, storage, shipment and handling prior to installation. The highly reflective asphalt-based roofing membrane 10 is typically between 36 and 40 inches in width and typically comes in 1 square (108 square foot) rolls.

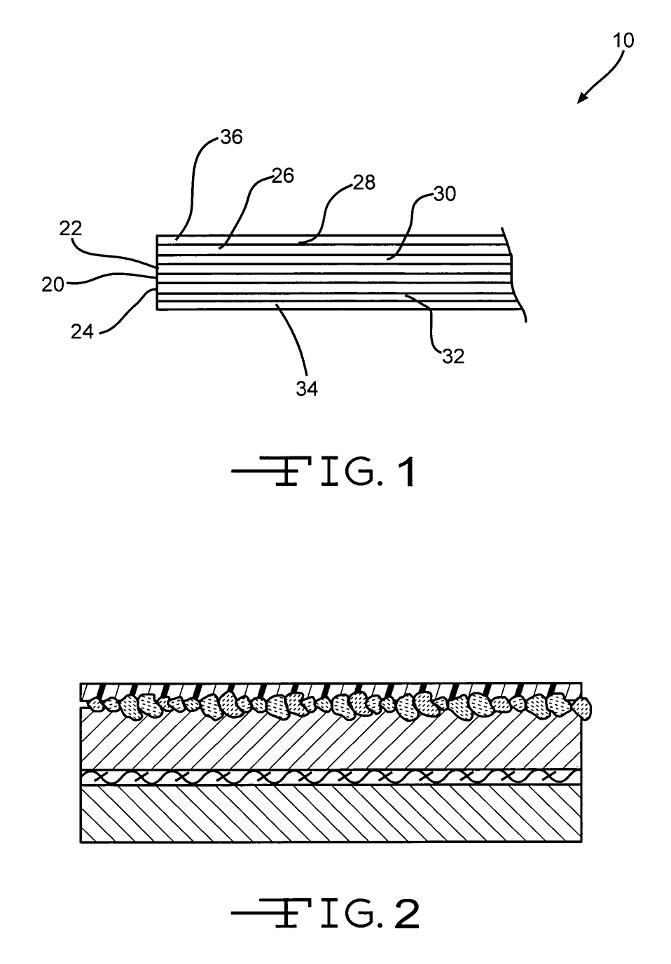

As illustrated in FIG. 1, the highly reflective asphalt-based roofing membrane 10 can include: a reinforcing substrate 20; asphalt with which the reinforcing substrate 20 is saturated and which forms top and bottom layers 22 and 24 encapsulating the reinforcing substrate; and a top coating layer 26 with a highly reflective and emissive top surface 28 that is coextensive with or substantially coextensive with the top major surface 12 of the highly reflective asphalt-based roofing membrane 10. With further reference to FIG. 1, as used herein, the “top layer” of the roofing membrane corresponds to the top coating layer 26 with the highly reflective and emissive top surface 28; and the “bottom layer” of the roofing membrane corresponds to the asphalt top and bottom layers 22 and 24 (and the encapsulated reinforcing substrate 20).

In an embodiment, the highly reflective asphalt-based roofing membrane 10 has a polymer primer layer 30, which is impermeable to the oils and other components of the asphalt. The impermeable polymer primer layer 30 is located between the highly reflective and emissive coating layer 26 and the top surface of the top asphalt layer 22 to prevent the exuding of oils and other components from the asphalt into the highly reflective and emissive coating layer 26 and to thereby prevent the oils and other components of the asphalt from staining and otherwise discoloring or adversely affecting the highly reflective and emissive top surface 28 of the coating layer 26. In addition, the highly reflective asphalt-based roofing membrane 10 normally includes a bottom surface layer 32 formed of conventional mineral surfacing materials, such as but not limited to such as mica, talc, sand, etc., chemical release agents, and/or polymeric film.

A release film 34 may overlie the bottom surface layer 32 of the roofing membrane to keep the bottom major surface 14 of the highly reflective asphalt-based roofing membrane 10 from adhering to or discoloring the highly reflective and emissive coating layer 26 of top major surface 12 of the highly reflective asphalt-based roofing membrane 10 when the highly reflective asphalt-based roofing membrane is wound into a roll. A release film 36 may overlie the top surface 28 of the highly reflective and emissive coating layer 26 and thus the top major surface 12 of the highly reflective asphalt-based roofing membrane 10 to maintain the cleanliness of the top surface 28 of the highly reflective and emissive coating layer 26. Where a release film 34 is not used on the bottom major surface of the highly reflective asphalt-based roofing membrane 10, the release film 36 also functions to keep the bottom major surface 14 of the highly reflective asphalt-based roofing membrane 10 from adhering to or discoloring the top major surface 12 of the highly reflective asphalt-based roofing membrane 10 when the highly reflective asphalt-based roofing membrane is wound into a roll. The surfaces of the release films 34 and 36 in contact with the bottom and top major surfaces of the highly reflective asphalt-based roofing membrane 10 are treated with conventional release agents, e.g., silicone or some other conventional release agent, so that the films 34 and 36 may be easily peeled off of the major surfaces of the highly reflective asphalt-based roofing membrane 10 during installation.

The reinforcing substrate 20 of the highly reflective asphalt-based roofing membrane 10 may be any of the conventional reinforcing substrates commonly used in highly reflective asphalt-based roofing membranes to provide the roofing membranes with the necessary strength and flexibility, such as, but not limited to: a non-woven fiberglass mat, a reinforced fiberglass mat, a non-woven polyester mat, a reinforced polyester mat, a veiled scrim of various fiber combinations, or a laminated composite of two or more of the preceding reinforcing substrates.

The compositions of the asphalt saturating the reinforcing substrate 20 and forming the top and bottom layers 22, 24 on the reinforcing substrate 20 may be any of the asphalt compositions discussed above and/or commonly used in highly reflective asphalt-based roofing membranes. These asphalt compositions may include fire retardant chemicals, and typically, range from mineral filled oxidized asphalts to polymer-modified asphalts that are modified with modifiers, such as thermoplastics [Amorphous Polypropylene (APP)], rubbers [Styrene-Butadiene-Styrene (SBS)], and other polymers, antioxidants, resins, oils, etc. The polymer-modified asphalts may also include mineral fillers.

The highly reflective and emissive coating layer 26 are composed of a polymer binder material or materials and a reflective and emissive pigment or pigments, for example, a white pigment, such as but not limited to titanium dioxide, zinc oxide, aluminum oxide, other mineral pigments, or a combination of these pigments in quantities sufficient to make the coating layer 26 both opaque to solar radiation and highly reflective and emissive. The pigments in the highly reflective and emissive coating layer 26 protect: the impermeable polymer primer layer 30 (when used); the polymer binder materials of the coating layer 26; and the underlying asphalt layer 22 of the asphalt saturated and coated reinforcing substrate 20 from the deleterious effects of ultraviolet radiation. The highly reflective and emissive coating layer 26 may also include additional additives that: aid in limiting the growth of fungi during service; improve fire resistance; enhance heat, light and impact stability; improve the application and flow characteristics of the coating (slip agents, surfactants, thickeners, viscosity depressants, etc.); and reduce the aging rate, discoloration, and dirt adherence of the coating during service. While the highest reflectance values require the highly reflective and emissive coating layer 26 to have smooth top surface 28, the top surface 28 of the highly reflective and emissive coating layer 26 may be embossed to enhance the appearance of the top major surface 12 of the highly reflective asphalt-based roofing membrane 10 and make the top major surface 12 of the highly reflective asphalt-based roofing membrane 10 more skid and slip resistant. The highly reflective and emissive coating layer 26 may include a surfacing material or surfacing materials (such as but not limited to reflective and emissive granules, typical roofing granules, mica, talc, etc.) intermediate the top asphalt layer 22 or the primer layer 30 and the highly reflective and emissive coating layer 26 or on and bonded or embedded in the top surfaces of highly reflective and emissive coating layer 26 to enhance the appearance of the top major surface 12 of the highly reflective asphalt-based roofing membrane 10 and/or make the top major surface 12 of the highly reflective asphalt-based roofing membrane 10 more skid and slip resistant.

There are several families of polymer binders that are well suited for use as the polymer binder materials in the highly reflective and emissive coating layer 26 to carry the highly reflective and emissive pigments of the highly reflective and emissive coating layer 26 and bind the highly reflective and emissive pigments of the highly reflective and emissive coating layer 26 to the top asphalt layer 22 or the impermeable polymer primer layer 30 (when used). Acrylic and isocyanate-based elastomers are particularly well suited for use as the polymer binder materials in the highly reflective and emissive coating layer 26. Due to their fast curing times; their durability when subjected to weathering forces, chemical contaminants, and solar radiation while in service on rooftops; their low glass transition temperatures (the property of remaining flexible at low temperatures); their low or nonexistent volatile organic compound emissions (voc emissions) during application; and their ability to be reapplied at the job site should the highly reflective and emissive top surface 28 of the roofing membrane be damaged.

Isocyanate elastomers are formed by reacting polyisocyantes with polyester or polyester resins (urethanes) or with polyamines (polyurea). Polyurea elastomers exhibit extremely fast reaction kinetics and cure. Polyurea elastomers may be derived from condensing an isocyanate component and a resin blend component. The isocyanate component may be aromatic or aliphatic in nature and may be a monomer, polymer, or any variant reaction of isocyanates, quasi-prepolymer, or a prepolymer. The prepolymer, quasi-prepolymer may be made of an amine-terminated polymer resin, or a hydroxyl-terminated polymer resin. The aliphatic variant exhibits the best resistance to yellowing (it does not yellow) with exposure to ultraviolet radiation. In an embodiment, the resin blend is made up of amine-terminated polymer resins and/or amine-terminated chain extenders. The amine-terminated polymer resins will not have any intentional hydroxyl moieties. Any hydroxyls are a result of an incomplete conversion to the amine-terminated polymer resins. The resin blend may also contain additives or non-primary components. These additives may contain hydroxyls, such as pre-dispersed pigments in a polyol carrier. Normally, the resin blend will not contain a catalyst. Polyurea coatings may also be comprised of aspartic esters, which provide amine functionality.

In the application of the highly reflective and emissive coating layer 26 to the top asphalt layer 22 of the roofing membrane 10, incompatibility between the acrylic or isocyanate elastomers of the coating layer 26 and the asphalt (e.g., oxidized or polymer modified asphalt) of the asphalt layer 22 is a primary concern. This interaction can result in the exudation of oils and other colored components out of the asphalt into the pores or structure of the highly reflective and emissive coating layer 26. The exudation of such oils and other colored components into the highly reflective and emissive coating layer 26 can cause permanent staining and discoloration of the highly reflective and emissive top surface 28 of the coating layer 26. In addition, the exudation of such oils into the elastomers of the coating layer 26 may also exacerbate the aging rate of or otherwise adversely affect the coating layers. To prevent any significant exudation of oils and other colored components from the asphalt layer 22 into the coating layer 26, the polymer primer layer 30 that are impermeable or substantially impermeable to the oils and other colored components of the asphalt in the asphalt layer 22 may be located intermediate the top surface of the asphalt layer 22 and the bottom surfaces of the highly reflective and emissive coating layer 26. Suitable polymer primers for the layer 30 include those containing polyvinyl acetate, polyvinylidene chloride, cured polyacrylonitrile, cellulose polymers, and others such as disclosed in U.S. Pat. No. 4,442,148. The disclosure of U.S. Pat. No. 4,442,148 is hereby incorporated herein in its entirety by reference. Other polymer primers than those set forth above that will block or substantially block the exudation of oils and other colored components from the asphalt may also be used.

Referring to FIG. 2, an exemplary asphalt-based membrane can comprise one or more asphalt layers, with an asphalt layer often comprising the bottom of the roofing membrane as installed. The asphalt-based membrane can be reinforced with (a layer of) polyester, organic, or glass reinforcement. In addition to an acrylic latex top surface coating, the roofing membrane can additionally include (ceramic coated) granules located between an asphalt layer and the acrylic latex top surface coating.

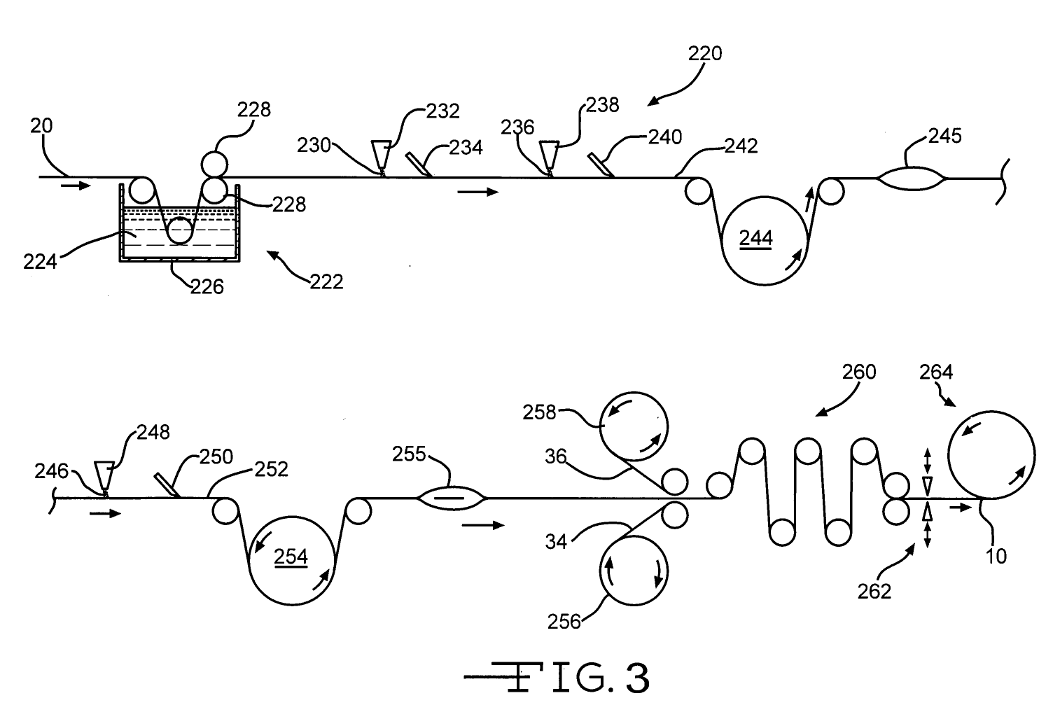

FIG. 3 schematically illustrates a typical manufacturing line 220 that could be used for making the highly reflective asphalt-based roofing membrane 10. As shown in FIG. 3, the reinforcing substrate 20 may be passed through a standard saturator/coater unit 222 or a standard saturator unit and a standard coater unit (not shown) where the reinforcing substrate 20 is saturated and coated with asphalt 224 at temperatures typically between 300 to 425° F. The saturator/coater unit 222 of FIG. 3 includes a tank 226 that contains the asphalt 224 and squeeze rollers 228. The asphalt 224 may be any of the asphalt compositions discussed above and/or commonly used in the industry to make highly reflective asphalt-based roofing membranes and typically contains asphalt and mineral fillers and may contain modifiers, such as thermoplastics [Amorphous Polypropylene (APP)], rubbers [Styrene-Butadiene-Styrene (SBS)], and other polymers, antioxidants, resins, oils, etc. Where the saturator and coater units are separate, the asphalts used in the saturator unit to saturate the reinforcing substrate 20 and in the coater unit to coat the reinforcing substrate 20 and build up the thickness of the saturated and coated reinforcing substrate 20 may have the same composition or different compositions.

As shown in FIG. 3, the reinforcing substrate 20 is saturated and coated with the asphalt 224 by passing the reinforcing substrate 20 through a pool of asphalt 224 in the tank 226. The thicknesses of the top and bottom asphalt layers 22, 24 of the asphalt saturated and coated reinforcing substrate 20 and the overall thickness of the asphalt saturated and coated reinforcing substrate 20 are then set by passing the saturated and coated reinforcing substrate between the spaced apart squeeze rollers 228. The spaced apart squeeze rollers 228 distribute the asphalt 224 evenly throughout the reinforcing substrate and over the top and bottom surfaces of the reinforcing substrate to form the built up layers of asphalt 22, 24 on the top and bottom surfaces of the reinforcing substrate 20.

A polymer primer layer 30 that is impermeable or substantially impermeable to the oils and other colored components of the asphalt 224 is then applied to the top surface of the top asphalt layer 22. The polymer primer material 230 that forms the polymer primer layer 30 would typically be applied to the top surface of the top asphalt layer 22 after the top asphalt layer 22 has been cooled to a temperature below 300° F. To form the polymer primer layer 30 of the roofing membrane 10, the polymer primer material 230 would be applied (e.g., poured or sprayed) across the entire width of the top surface of the top asphalt layer 22 by an applicator 232. The pool of polymer primer material 230 thus formed then passes beneath a doctor blade 234 that smoothes the top surface of the polymer primer material and forms the pool of polymer primer material into the polymer primer layer 30. The polymer primer layer 30 is then typically air dried or cured prior to applying the pigment filled polymer binder material 236 that is formed into the highly reflective and emissive coating layer 26. While the technique shown for applying the polymer primer material 230 to the top surface of the top asphalt layer 22 is a spread coating technique, it is contemplated that the polymer primer material 230 could be applied to the top surface of the top asphalt layer 22 by other techniques commonly used in the industry, such as but not limited to, dip coating, roll coating, spray coating, and powder coating techniques.

Where the polymer primer material 230 is utilized to provide the roofing membrane 10 with the polymer primer layer 30, after the polymer primer layer 30 is dried, the pigment filled polymer binder material 236 that is formed into the highly reflective and emissive coating layer 26 may be poured or sprayed in liquid form onto the top surface the polymer primer layer 30 by an applicator 238. Where the polymer primer material 230 is not utilized to form the polymer primer layer 30 between the asphalt layer 22 and the highly reflective and emissive coating layer 26 of the roofing membrane 10, the pigment filled polymer binder material 236 that is formed into the highly reflective and emissive coating layer 26 could be poured or sprayed in liquid form across the entire width of and directly onto the top surface of the top asphalt layer 22 by the applicator 238. The pool of pigment filled polymer binder material 236 thus formed then passes beneath a doctor blade 240 that smoothes the top surface of the pigment filled polymer binder material 236 and forms the pool of pigment filled polymer binder material 236 into the highly reflective and emissive coating layer 26. The highly reflective and emissive coating layer 26 is formed by the doctor blade 240 to a desired thickness and smoothness that is sufficient to provide the highly reflective and emissive coating layer 26 and the highly reflective asphalt-based roofing membrane 10 with the necessary reflectance and emittance.

While the technique shown for applying the pigment filled polymer binder material 236 to the top surface of the polymer primer layer 30 or the top surface of the top asphalt layer 22 is a spread coating technique, it is contemplated that the pigment filled polymer binder material 236 could be applied to the top surface of the polymer primer layer 30 or the top surface of the top asphalt layer 22 by other techniques commonly used in the industry, such as but not limited to, dip coating, roll coating, spray coating, and powder coating techniques. Where the pigment filled polymer binder material 236 is in powder form, the pigment filled polymer binder material 236 can be heated by a heater (not shown) to melt the powder or the surface temperature of the polymer primer layer 30 or the top asphalt layer 22 is hot enough to melt the pigment filled polymer binder material 236 to form a pool of the pigment filled polymer binder material 236.

With the highly reflective and emissive coating layer 26 applied to the top surface of the asphalt layer 22 or the top surface of the polymer primer layer 30, the laminate 242 thus formed by the asphalt saturated and coated reinforcing substrate 20 with the highly reflective and emissive coating layer 26 or the polymer primer layer 30 and the highly reflective and emissive coating layer 26 may be passed around a first press drum 244. As the laminate 242 passes around the first turnover press drum 244, the layers 22, 26 or 22, 30, 26 of the roofing membrane 10 are pressed together to assure good adhesion between the layers. As or after the laminate 242 passes over the first press drum 244, the laminate is flipped (represented schematically by 245 in FIG. 3) so that the bottom surface of the bottom asphalt layer 24 of the laminate is facing upward. This permits the application of surfacing materials (such as sand, other minerals (e.g., mica, talc, etc.), chemical release agents, and/or polymeric films) to the bottom surface of the laminate 242.

In FIG. 3, bottom surfacing material(s) 246 that form the bottom surface layer 32 of the roofing membrane 10 are shown being poured or sprayed onto the bottom surface of the bottom asphalt layer 24 by an applicator 248. To form the bottom surface layer 32 of the roofing membrane 10, the surfacing materials 246 would be poured, sprayed or otherwise applied across the entire width of the bottom surface of the bottom asphalt layer 24 by an applicator 248. The layer of surfacing material(s) thus formed then passes beneath a doctor blade 250 that smoothes the normally bottom surface of the surfacing material(s) and forms the layer of surfacing material(s) into a bottom surface layer 32 having a desired thickness and smoothness.

The laminate 252 thus formed is then passed around a second press drum 254 where the surfacing materials 246 applied to the normally bottom surface of the asphalt layer 24 of the laminate 252 are pressed into the bottom surface of the asphalt layer 24 to assure good adhesion between the surfacing material(s) 246 and the asphalt layer 24. After the laminate 252 passes over the second turnover press drum 254, the laminate 252 is then flipped (represented schematically by 255 in FIG. 3) and returned to its normal orientation.

After the application of the top layers 22, 26 and the bottom layers 24, 32 or the top layers 22, 30, 26 and bottom layers 24, 32 to the top and bottom surfaces of the asphalt saturated and coated reinforcing substrate 20, the laminate 252 formed is rapidly cooled by water-cooled rolls and/or water sprays. The laminate 252 is then passed through a drying section where the composite is air dried/cured to solidify the highly reflective and emissive top coating layer 26 and the bottom layer 32 and complete the manufacture of the highly reflective asphalt-based roofing membrane 10. A bottom release film 34 is applied to the bottom surface layer 32 and a top release film 36 is applied to the top surface of the highly reflective and emissive coating layer 26 of the highly reflective asphalt-based roofing membrane 10 from rolls 256 and 258.

The highly reflective asphalt-based roofing membrane 10 is then fed through a looper or accumulator section 260 to permit the continuous movement of the highly reflective asphalt-based roofing membrane 10 during the cutting and winding operation. In the cutting and winding operation, the highly reflective asphalt-based roofing membrane 10 is periodically cut to a desired length or lengths by a cutting unit 262 and wound into rolls 264 for packaging, storage, and shipment to a job site.

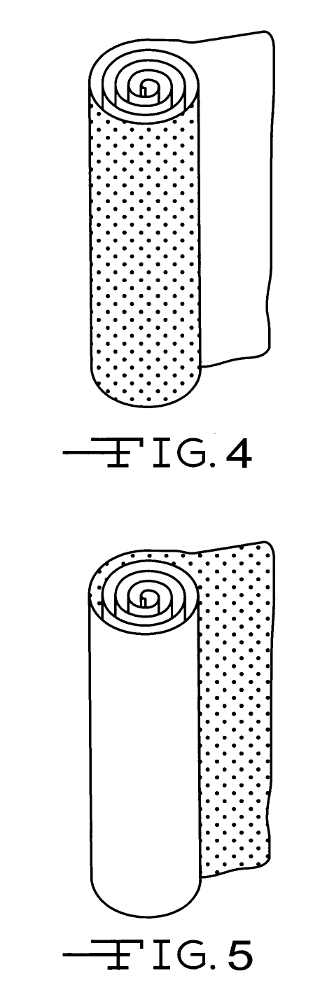

Referring to FIG. 4, it is possible to wind a roofing membrane having an acrylic latex top surface and an asphalt layer into a roll such that the acrylic latex top surface faces inward and the asphalt layer faces outward. However, such an arrangement can lead to cracking in the roofing membrane, as described further below. In contrast, and in accordance with FIG. 5, in an embodiment, the present disclosure describes a roofing membrane having an acrylic latex top surface and an asphalt layer wound into a roll such that the acrylic latex top surface faces outward and the asphalt layer faces inward.

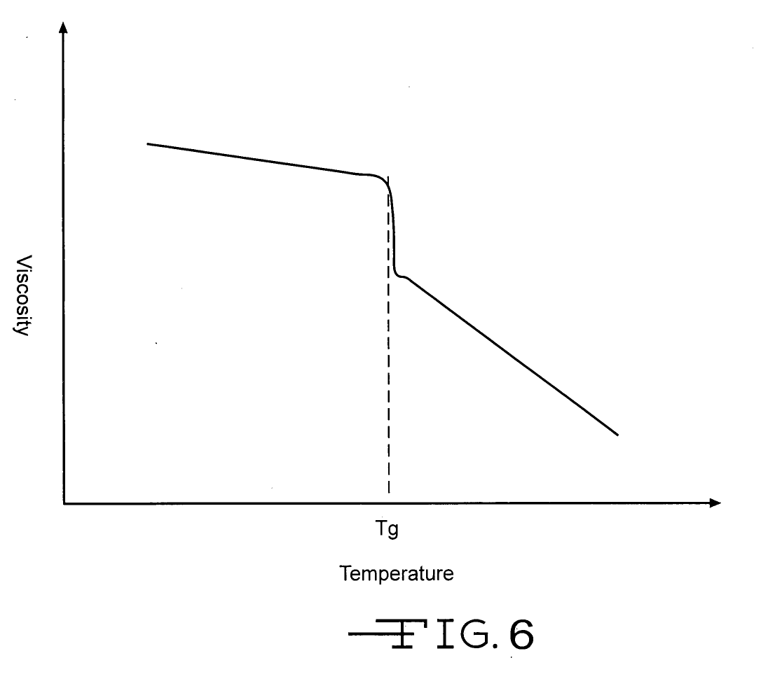

Without wishing to be bound by any theories, it is believed that the mechanism for crack formation is tensile stress formation during unwinding in an elastomeric top layer of a roofing membrane. FIG. 6 is a graph of a viscosity versus temperature curve for a typical elastomeric material. As the temperature increases, the viscosity decreases, i.e., the fluidity increases. As a result, the stress relaxation of the elastomeric material is faster at higher temperatures than that at lower temperatures.

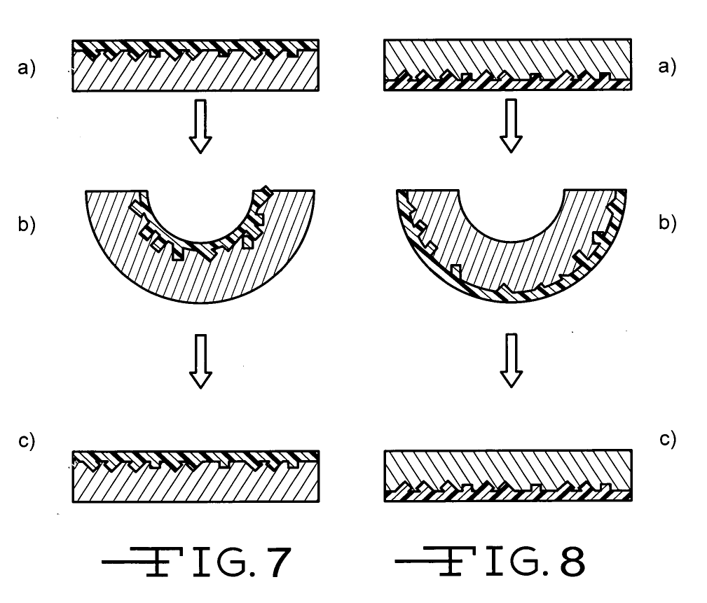

Thus, referring to FIG. 7, upon application of the acrylic latex top surface [a)], the acrylic latex top surface experiences no stress as it is in a flat state during this step in the manufacturing process. However, upon winding of the roofing membrane into a roll such that the acrylic latex top surface faces inward and the asphalt layer faces outward [b); see also FIG. 4], the acrylic latex top surface experiences compressive stress. However, the compressive stress experienced by the acrylic latex top surface is quickly relaxed because the temperature is high (as a result of recent processing). During unrolling of the roofing membrane [c)], the compressive stress experienced by the acrylic latex top surface experiences is relieved. The relief of compressive stress in the acrylic latex top surface, in effect, creates comparative tensile stress in the acrylic latex top surface, which causes cracks, especially in cold weather. As the amount of curvature when rolled is proportional to the amount of comparative tensile stress that results during unrolling, crack are more easily formed in the inner portion of the roll (i.e., where the curvature of the roll is greatest).

After unrolling of the roofing membrane illustrated in FIGS. 4 and 7, the roofing membrane must be inverted to ensure thermal relaxation of the membrane by exposing the asphalt layer to solar energy. If the roofing membrane is not inverted such that the asphalt layer is exposed to solar energy, the acrylic latex top surface will, by design, reflect solar energy rather than absorb it, thus inhibiting relaxation.

Referring now to FIG. 8, upon application of the acrylic latex surface [a); illustrated in FIG. 8 as a bottom acrylic latex surface], again, the acrylic latex surface experiences no stress. However, upon winding of the roofing membrane into a roll such that the acrylic latex surface faces outward and the asphalt layer faces inward [b); see also FIG. 5], the acrylic latex surface experiences tensile stress. The tensile stress experienced by the acrylic latex surface is quickly relaxed because the temperature is high (as a result of recent processing). In contrast, during unrolling of the roofing membrane [c)], the tensile stress experienced by the acrylic latex surface experiences is relieved. The relief of tensile stress in the acrylic latex surface, in effect, creates comparative compressive stress in the acrylic latex surface, which avoids and/or prevents cracks from generating. The amount of curvature when rolled is proportional to the amount of comparative compressive stress that results during unrolling. Again, the curvature of the roll is greatest at the inner portion of the roll. Installation of the roofing membrane illustrated in FIGS. 5 and 8, depending on the installation method, can reduce the labor required for installation of the roofing membrane by removing the need for the inversion step discussed above with regard to the installation of the roofing membrane illustrated in FIGS. 4 and 7.

As the acrylic latex surface experiences comparative compressive stress during unrolling, the asphalt layer experiences comparative tensile stress during unrolling. However, as the (cured) elastomeric top layer is less ductile than the asphalt layer, the asphalt layer should not crack as a result of the comparative tensile stress in the asphalt layer that results during unrolling. In contrast, the less ductile elastomeric top layer would crack as a result of a comparable comparative tensile stress in the elastomeric top layer resulting during unrolling.

The comparative compressive stress in the acrylic latex top surface additionally serves as an extra protection against the manipulation (e.g., turning, flipping, etc.) experienced by the acrylic latex top surface during installation of the roofing membrane. Tension applied to the roofing membrane during installation must overcome the comparative compressive stress in order for the acrylic latex top surface to crack. The positive characteristic of the comparative compressive stress in the acrylic latex top surface is enhanced when unrolling the roofing membrane in cold weather, as the comparative compressive stress in the acrylic latex top surface is not easily relaxed in cold weather (e.g., temperatures below about 50° F.).

While various embodiments have been described, it is to be understood that variations and modifications may be resorted to as will be apparent to those skilled in the art. Such variations and modifications are to be considered within the purview and scope of the claims appended hereto.

What is claimed is:

1. A rolled sheet product, wherein the sheet product comprises a top layer and a bottom layer, wherein the top layer is less ductile than the bottom layer, and wherein the top layer faces outward in the rolled sheet product.

2. The rolled sheet product of claim 1, wherein the sheet product comprises a roofing membrane.

3. The rolled sheet product of claim 1, wherein the top layer comprises an elastomeric layer.

4. The rolled sheet product of claim 3, wherein the elastomeric layer comprises an acrylic latex layer.

5. The rolled sheet product of claim 3, wherein the bottom layer comprises an asphalt layer.

6. The rolled sheet product of claim 5, wherein the asphalt comprises modified bitumen.

7. The rolled sheet product of claim 5, wherein the rolled sheet product further comprises at least one intermediate layer of polyester or glass reinforcement.

8. A method of packaging a sheet product comprising a top layer and a bottom layer, wherein the top layer is less ductile than the bottom layer, the method comprising:
winding the sheet product into a roll such that the top layer faces outward.

9. The method of claim 8, wherein the sheet product comprises a roofing membrane.

10. The method of claim 8, wherein the top layer comprises an elastomeric layer.

11. The method of claim 10, wherein the elastomeric layer comprises an acrylic latex layer, the bottom layer comprises an asphalt layer, and the sheet product further comprises at least one intermediate layer of polyester or glass reinforcement.

12. A method of installing a roofing membrane comprising an elastomeric top layer, the method comprising:
winding the roofing membrane into a roll such that the elastomeric top layer faces outward;
transporting the roofing membrane to a roof; and
unrolling the roofing membrane on the roof such that the elastomeric top layer faces upward.

13. The method of claim 12, wherein the elastomeric top layer comprises an acrylic latex layer.

14. The method of claim 13, wherein the acrylic latex layer comprises a water based acrylic latex coating.

15. The method of claim 12, wherein the roofing membrane further comprises:
at least one asphalt layer; and
at least one layer of polyester or glass reinforcement.

16. The method of claim 15, wherein the roofing membrane further comprises:
ceramic coated granules located between asphalt layer and the elastomeric top layer.

17. An installed roofing membrane comprising an elastomeric top layer, the elastomeric top layer experiencing less tensile stress than an amount of tensile stress experienced by the elastomeric top layer prior to installation.

18. The installed roofing membrane of claim 17, wherein the elastomeric top layer comprises an acrylic latex layer.

19. The installed roofing membrane of claim 17, wherein the roofing membrane further comprises:
at least one asphalt layer; and
at least one layer of polyester or glass reinforcement.

20. The installed roofing membrane of claim 19, wherein the roofing membrane further comprises:
ceramic coated granules located between an asphalt layer and the elastomeric top layer.
